(19) United States
(12) Patent Application Publication
(10) Pub. No.: US 2026/0059474 A1
(43) Pub. Date: Feb. 26, 2026

(54) SIDELINK POSITIONING REFERENCE SIGNAL TRANSMISSION FOR WIRELESS COMMUNICATIONS

(71) Applicant: ZTE CORPORATION, Shenzhen, Guangdong (CN)

(72) Inventors: Yu PAN, Shenzhen (CN); Chuangxin JIANG, Shenzhen (CN); Shujuan ZHANG, Shenzhen (CN); Mengzhen LI, Shenzhen (CN); Jing LIU, Shenzhen (CN)

(21) Appl. No.: 19/102,543

(22) PCT Filed: Aug. 10, 2022
(86) PCT No.: PCT/CN2022/111553

§ 371 Date: Feb. 10, 2025

(51) Int. Cl. H04W 64/00; H04L 1/1607; H04W 72/25

(52) U.S. Cl. CPC H04W 64/00; H04L 1/1614; H04W 72/25

(57) ABSTRACT

This document generally relates to wireless communication that includes: a user device that determines a sidelink positioning reference signal (SL-PRS) configuration, and transmits a periodic SL-PRS according to the SL-PRS configuration. Additionally, a user device receives a SL-PRS, and performing at least one measurement based on the periodic SL-PRS.

### CROSS-REFERENCE TO RELATED APPLICATION

The present disclosure is a national stage filing under 35 U.S. C. § 371 of international application number PCT/CN2022/111553 filed Aug. 10, 2022 and entitled “sidelink positioning reference signal transmission for wireless communications”, which is incorporated herein by reference in its entirety.

### TECHNICAL FIELD

This document is directed generally to sidelink positioning for wireless communication.

### BACKGROUND

In some situations involving sidelink (SL) wireless communication, out-of-coverage user devices may share the same pre-defined positioning reference signal (PRS) configuration. This, in turn, may cause resource conflicts and/or interference issues. Ways to avoid or minimize the risk of these problems for such situations may be desirable.

### SUMMARY

This document relates to methods, systems, apparatuses and devices for wireless communication. In some implementations, a method for wireless communication includes: determining, with a user device, a sidelink positioning reference signal (SL-PRS) configuration; and transmitting, with the user device, a periodic SL-PRS according to the SL-PRS configuration. In some other implementations, a method for wireless communication includes: receiving, with a user device, a periodic sidelink positioning reference signal (SL-PRS); and performing, with the user device, at least one measurement based on the periodic SL-PRS.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example layer configuration of a user device.

FIG. 3 shows a block diagram of another example layer configuration of a user device.

FIG. 4 shows a block diagram of another example layer configuration of a user device.

FIG. 5 shows a diagram example timing-based sidelink positioning method.

FIG. 6 shows a flow chart of an example method of wireless communication related to sidelink positioning.

FIG. 7 shows a flow chart of another example method of wireless communication related to sidelink positioning.

### DETAILED DESCRIPTION

The present description describes various embodiments of systems, apparatuses, devices, and methods for wireless communications involving sidelink positioning.

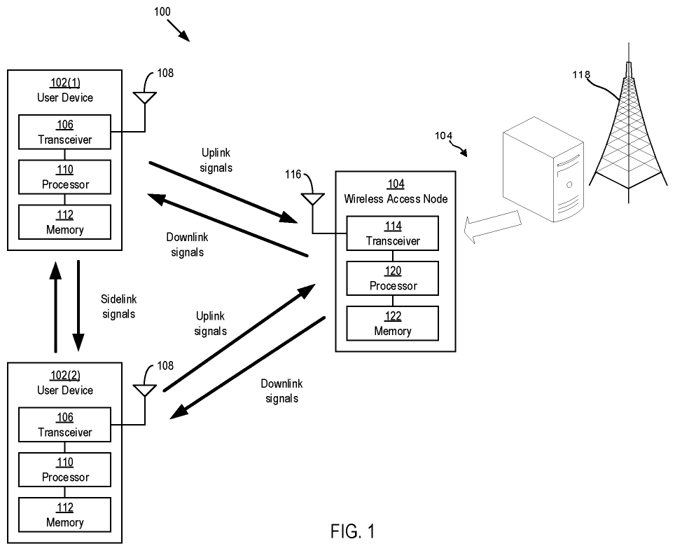

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples), a road side unit (RSU), a positioning reference unit (PRU), a device affixed or attached, to a pedestrian, or a fixed or stationary device, (such as a desktop computer or other computing device that is not ordinarily moved for long periods of time, such as appliances, other relatively heavy devices including Internet of things (IOT), or computing devices used in commercial or industrial environments, as non-limiting examples). In addition, in any of various embodiments, a user device 102 may be an electronic device that supports V2X service and/or sidelink communication. In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Also, as described in further detail below, a given user device 102 may take on a role of, or be configured or function as, a type of user device, including a target user device or an anchor user device. In general, a target user device is a user device that wants to acquire its own location by sidelink positioning, and/or is a user device that receives a location request from the wireless access node (i.e., the network). In addition, an anchor user device is a user device to which an initiating user device transmits a sidelink positioning reference signal (SL-PRS) or from which an initiating user device receives a SL-PRS. A target user device and an anchor user device may form a user device (or UE) pair. Also, an anchor device may facilitate absolute sidelink (SL) positioning by knowing its precise location. Further details of target, anchor, and initiating user devices are described in further detail below.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

Additionally, in various embodiments, two or more of the communication nodes in the wireless system 100, may be configured to communicate according to vehicle networking standards and/or specifications. As used herein, vehicle networking refers to a large scale system for wireless communication and information exchange involving a vehicle, pedestrians, roadside equipment and the Internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

Also, in various embodiments, two or more of the communication nodes may communicate with each other using a V2X application server. In some embodiments, a V2X application server may exist (or be present or configured in) a user device 102. In other embodiments, a V2X application server may exist or be present or configured outside of (external to) a user device 102 in order to take control of multiple user devices 102. In still other embodiments, a V2X application server may exist or be present or configured in a wireless access node 104. For embodiments where the V2X application server is in the wireless access node 104, the wireless access node 104 may transmit information to a user device 102 via a uu interface. Also, for embodiments where the V2X application server is in a user device 102, the user device 102 transmits information to other user devices 102 via a PC5 interface.

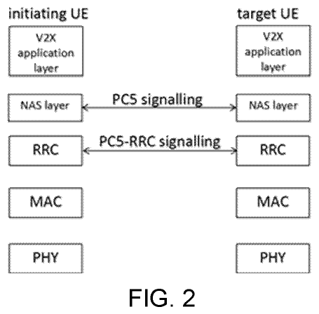

FIG. 2 shows a block diagram of a plurality of layers of a user device 102 (such as an initiating user device and a target user device), including a physical layer (PHY) (also called herein PHY module or PHY entity), a medium-access control (MAC) layer (also called herein MAC module or MAC entity), a radio resource control (RRC) layer (also called herein RRC entity or RRC module), a Non-Access Stratum (NAS) layer (also called herein NAS entity or NAS module), and a V2X application layer (also called herein V2X application entity or V2X application module).

In general, as used herein unless expressed otherwise, the terms “layer”, “entity”, and “module”, used alone or in combination with each other, and as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a layer, module or entity performs may be defined by one or more standards or protocols, such as 5G NR for example. Additionally, the layers in FIG. 2 may be higher and lower layers relative to each other in accordance with their relative positioning shown in FIG. 2, with the PHY layer being the lowest layer among the layers, the V2X application layer being the highest layer, and so on. In various embodiments, a communication node of the system 100 may include more, less, or other layers other than those shown in FIG. 2.

As shown in FIG. 2, the V2X application layer can be seen as a logical layer to generate, carry and/or convery information from a V2X application server. The V2X application layer may be the same or different as a V2X layer. For at least some embodiments, both the V2X application layer and the V2X layer may be considered higher than the RRC layer with respect to one user device 102. In addition, as shown in FIG. 2, two user devices 102 (e.g., an initiating user device 102 and a target user device 102) may communicate via their respective NAS layers. A NAS layer may be higher than the RRC layer but lower than the V2X application layer. For some embodiments, such as shown in FIG. 2, two user devices 102 may perform PC5-S (or just PC5) signaling between their respective NAS layers. In this context, PC5 signaling may be considered NAS layer signaling.

Additionally, the V2X application layer or NAS layer may indicate to lower layers (such as the RRC, MAC, and PHY layers) control parameters for transmitting or receiving V2X transmission. In various embodiments, the V2X application layer and/or the NAS layer may also generate V2X service data and pass it to one or more lower layers for transmission to other user devices 102. As used herein, the application layer and the NAS layer and be used interchangeably or be considered the same layer, unless expressly specified otherwise. Also, the V2X service data carried in PSSCH and can be transmitted via broadcast, groupcast or unicast. The transmission mode (broadcast, groupcast or unicast) is also chosen and indicated by the V2X application layer or the NAS layer, and the indication of cast type may be carried in the 2nd stage sidelink control information (SCI) in PSSCH.

Additionally, as used herein, PC5-S (or just PC5) signaling may also be referred to as PC5-S messaging, and/or PC-S may also be referred to as a PC5-S message. Also, although not shown in FIG. 2, a user device 102 may also be configured with a package data convergence protocol (PDCP) layer and/or a radio-link control (RLC) layer, which may be configured between the RRC layer and the MAC layer.

In addition, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

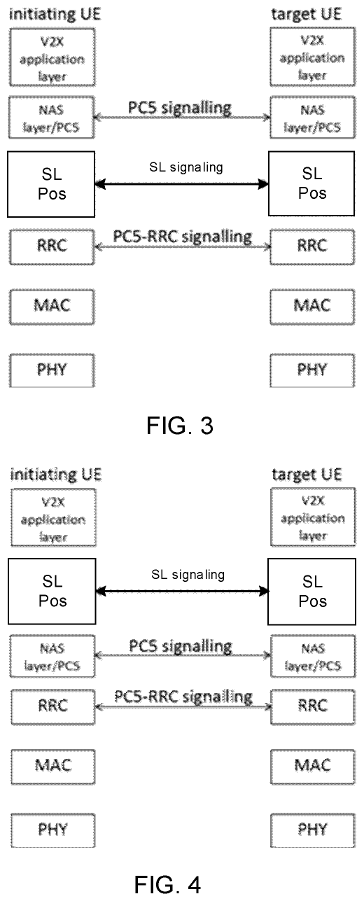

FIGS. 3 and 4 show block diagrams of other layer configurations for target and initiating user devices 102. As shown in each of FIGS. 3 and 4, in addition to the layers shown in FIG. 2, the layers may include a sidelink (SL) positioning (Pos) layer. The layer configuration in FIG. 3 has the SL positioning layer between the RRC layer and the NAS layer. In the layer configuration in FIG. 4, the SL positioning layer is between the V2X application layer and the NAS layer. Other layer configurations including a SL positioning layer may be possible. For example, the SL positioning layer may be configured to be parallel with the NAS layer, the RRC layer, or the V2X application layer. In still other embodiments, the SL position layer may be included or contained within, or otherwise part of, another layer, such as the NAS layer or the V2X application layer. Also, as indicated in FIGS. 3 and 4, and as used herein, the signaling transferred in the SL positioning layer is referred to generally as SL signaling, and may include PC5 signaling, PC5-RRC signaling, or other types of signaling, such as in accordance with a SL positioning protocol. In addition or alternatively, the SL signaling conveyed in the SL positioning layer may also be nas messages and/or nas signaling.

Also, in various embodiments, a user device 102 as described, may be configured with any of the layer configurations described above, such as shown in FIGS. 2-4, irrespective of its coverage or the coverage of the other user device of its pair, including when both user devices 102 in a user device pair are in coverage or partial coverage of a network, or one of the user devices of the pair is in coverage or partial coverage the other one of the pair is out of coverage, or both user devices of the pair are out of coverage. In addition, a user device 102 is “in coverage” when the user device 102 is within reach of the wireless access node (e.g., the network) 104. That is, the user device 102 is capable of communicating with (i.e., transmitting signals to and/or receiving signals from) the wireless access node 104. Also, a user device 102 is “out of coverage” when the user device 102 is not within reach of a wireless access node (e.g., the network) 104. That is, the user device 102 not capable of communicating with (i.e., transmitting signals to and/or receiving signals from) the wireless access node 104. For at least some embodiments, Out of coverage user devices 102 may communicate with each other via a PC5 reference point. Also, a user device 102 is “in partial coverage” when the user device 102 has a connection with the wireless access node 1 (e.g., the network) 104, while also being able to communicate with other user devices 102 via a PC5 reference point.

In addition, in various embodiments, a sidelink (SL) assistance data configuration of a user device 102 to transmit may be provided by the wireless access node 104 (e.g., the network), or by pre-configuration, or may be self-configured or self-generated by the user device 102. For at least some embodiments, a pre-configuration of SL assistance data may be a default configuration of a user device 102. Additionally, the SL assistance data configuration for a user device 102 may include a transmitter (Tx) SL PRS configuration of the user device. As used herein, a Tx SL PRS configuration is a configuration of a sidelink positioning reference signal (SL-PRS) according to which a user device 102 is going to transmit a PRS. In addition, the assistance data configuration, in particular the Tx SL PRS configuration, of a user device 102 may be the same as, or different than, a assistance data configuration of one or more other user devices 102. Further, user devices 102 that are to perform SL positioning should know whether their respective Tx SL PRS configurations are the same as or different from each other. If different, SL PRS configuration delivery between user devices 102 may be used inform or notify other user devices 102 of each other's SL PRS configuration. By notifying each other of their SL PRS configurations, the user devices 102 may receive SL PRS correctly. For at least some embodiments, the SL assistance data information (including SL PRS configuration) may be generated or determined through self-configuration or pre-configuration by a user device 102, such as in one or more of its layers (e.g., the V2X application layer, NAS, MAC layer, RRC layer, or SL positioning layer, as non-limiting examples). For such embodiments, the SL PRS configuration is based on or specific to the implementation of the user device 102.

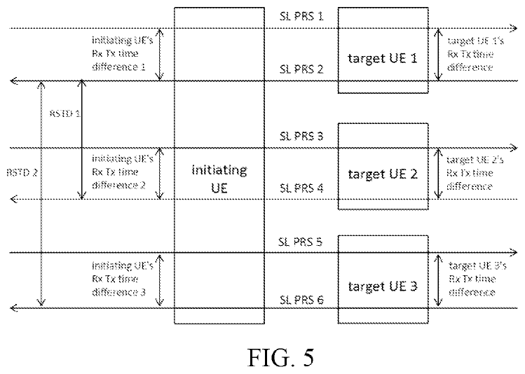

FIG. 5 shows an example of a timing-based SL positioning method. In various embodiments, such as shown in FIG. 5, a timing-based positioning method for sidelink communication may include: a target user device 102 may send multiple PRS resources (e.g., SL PRS 1, SL PRS 3, SL PRS 5). Then, multiple anchor user devices 102 may receive the PRS resources. The multiple anchor user devices 102 also send their respective PRS resources (e.g., SL PRS 2, SL PRS 4, SL PRS 6). Then, the target user device 102 may receive the PRS resources from the multiple anchor user devices 102. In response, the target user device 102 may perform or make reference signal time difference (RSTD) measurements between different PRS resources of different anchor user devices 102, such as between RSTD 1 and RSTD 2, for example. In addition, a target user device 102 may also make more or more multiple round trip time measurements between the PRS it sends and the PRS it receives. Each round trip time measurement may correspond to a respective one of the anchor user devices 102. For example, the target user device 102 may measure a receive-transmit (Rx Tx) time difference 1, a Rx Tx time difference 2, and a Rx Tx time difference 3, each of which may correspond to a respective one of three anchor user devices 102. Also, each anchor user device 102 may measure its round trip time between a received PRS from the target user device 102 and a PRS it sends. For example, a first anchor user device 102 may measure Rx Tx time difference 1 between a PRS it receives from the target user device 102 and a PRS it sends, a second anchor user device 102 may measure a Rx Tx time difference 2 between a PRS it receives and a PRS it sends, and a third anchor user device 102 may measure a Rx Tx time difference between a PRS it receives and a PRS it sends.

Also, in any of various embodiments, a user device 102 may transmit a SL PRS periodically, semi-persistently or dynamically. Correspondingly, a given SL PRS may be configured with a period for a periodic SL PRS. In turn, when a user device 102 receives a measurement request, the user device 102 may be ready to receive the periodic SL PRS. Also, for a semi-persistent SL PRS, one or more lower layers of a user device 102 may trigger one or more of the SL PRS transmissions from a higher layer configuration. In addition, for dynamic SL PRS, sidelink control information (SCI) may trigger a dynamic SL PRS transmission.

In addition, in various embodiments, a sidelink positioning session performed by a user device 102 may be the same as, similar to, or different than a positioning session involving Uu positioning or other types of positioning sessions. For example, the sidelink positioning session may be different from a mobile terminated location request (MT-LR) service triggered by a location service (LCS) client or a mobile originated location request (MO-LR) service triggered by the user device 102 itself. The user device 102 may use positioning session identifications in order to differentiate different positioning sessions. That is, different positioning session identifications may be assigned or correspond to different positioning sessions. The positioning session identifications may have any of various forms or formats, such as integers for example. Also, for at least some embodiments, a sidelink positioning session may be set up before other positioning procedures or sessions, such as before a user device 102 transmits a SL-PRS.

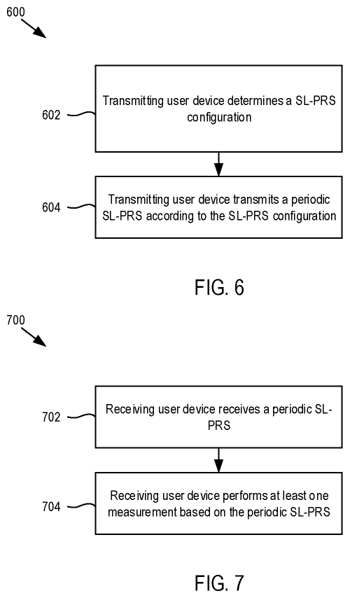

FIG. 6 shows a flow chart of an example method 600 for wireless communication that involves sidelink positioning. At block 602, a transmitting user device 102 determines a sidelink positioning reference signal (SL-PRS) configuration. At block 604, the transmitting user device 102 may transmit a periodic SL-PRS according to the SL-PRS configuration.

FIG. 7 shows a flow chart of another example method 700 for wireless communication that involves sidelink positioning. At block 702, a receiving user device 102 receives a periodic SL-PRS. At block 704, the receiving user device 102 may perform at least one measurement based on the periodic SL-PRS. The at least one measurement may include at least one of: reference signal time difference (RSTD), time of arrival (TOA), a Rx-Tx time difference measurement, SL-PRS reference signal received power (SL-PRS-RSRP), SL-PRS reference signal received power per path (SL-PRS-RSRPP), or the receiving angle of the periodic SL-PRS.

In various embodiments of the method 600 and/or the method 700, the SL-PRS configuration includes at least one of: a SL-PRS resource, a SL-PRS resource set, or a SL-PRS resource set list comprising a plurality of SL-PRS resource sets.

Also, in various embodiments, the transmitting user device 102 may broadcast at least one of: a user device identification, a positioning session identification, or the SL-PRS configuration. For some of these embodiments, the transmitting user device 102 may broadcast the user device identification, the positioning session identification, and/or the SL-PRS configuration before transmitting the periodic SL-PRS. In other embodiments, the transmitting user device 102 may broadcast at least one of the user device identification, the positioning session identification, the SL-PRS configuration, and/or a SL-PRS time stamp after transmitting the SL-PRS.

In addition or alternatively, for at least some embodiments, the transmitting user device 102 may be configured with a time period. Correspondingly, when the transmitting user device 102 transmits the periodic SL-PRS according to the SL-PRS configuration, the transmitting user device 102 may do so by transmitting the periodic SL-PRS within the time period. For at least some of these embodiments, the time period may be configured per SL-PRS configuration. That is, time periods utilized by the transmitting user device 102 and/or by the receiving user device 102 for SL-PRS communication may be configured on a per SL-PRS configuration basis. For a plurality of different time periods, each time period may correspond to and/or be configured by a respective one of a plurality of different SL-PRS configurations. In other embodiments of these embodiments, the time period is configured among a plurality of SL-PRS configurations. That is, different or separate SL-PRS configurations may share, correspond to, and/or configure the same time period.

In addition or alternatively, for at least some embodiments, the transmitting user device 102 and/or the receiving user device 102 may be configured with a time bitmap. Correspondingly, when the transmitting user device 102 transmits the periodic SL-PRS according to the SL-PRS configuration, the transmitting user device 102 may do so by transmitting the periodic SL-PRS according to an available time indicated by the time bitmap. In addition or alternatively, the transmitting user device 102 may receive a second SL-PRS within an available time indicated by the time bitmap. In addition or alternatively, the time bitmap may be configured according to a sidelink slot pattern. In addition or alternatively, the receiving user device 102 may receive the periodic SL-PRS by blindly detecting the periodic SL-PRS using at least one of: a user device identification or a PRS sequence identification.

In further detail, in even that a user device 102 is out of coverage (or in an out-of-coverage state), a high layer (e.g., the NAS layer or the V2X application layer) of the user device 102 may trigger a positioning service in order for the user device 102 to know or identify its absolute location or the distance and/or angle between the user device 102 and other neighbor user devices 102. The positioning service may request that the user device 102 perform a SL-PRS based positioning method, for example sidelink time difference of arrive (SL-TDOA), sidelink antenna on display (SL-AoD), sidelink angle-of-arrival (SL-AoA), sidelink multi-round trip time (SL-multi-RTT), as non-limiting examples.

Also, when an out-of-coverage user device 102 has a positioning service and determines to perform sidelink positioning, the user device 102 may broadcast a positioning service request with at least one of: its user device identification (ID) (for example, a UE ID, a source/destination user information, or a source/destination layer-2 ID), one or more sidelink positioning methods, a specific service type identification, or a positioning session identification. When a neighbor user device 102 receives the broadcast, if the neighbor user device 102 is interested in the specific positioning service, the neighbor user device 102 may, in response, return a confirm message. For at least some embodiments, the neighbor user device 102 may do so by broadcasting the confirm message or by triggering a direct PC5 link set up procedure. Also, for some embodiments, the confirm message may include at least one of: confirm indication that indicates that the neighbor user device 102 is confirming the positioning service request, the specific service type identification, the positioning session ID, or at least one user device identification (for example, at least one of: the UE ID of the user device 102 broadcasting the positioning service request, the UE ID of the neighbor user device 102 transmitting the confirm message, a source/destination user information of the neighbor user device 102, or a source/destination layer-2 ID of the neighbor user device 102). Upon transmission of the confirm message by the neighbor user device 102, the neighbor user device 102 and the user device 102 that initially broadcast the positioning service request may set up a sidelink positioning. When a positioning session is set up, the user devices belonging or that are part of the positioning session (e.g., the initial broadcasting user device 102 and the neighbor user device 102) may know each other's user device identification, and know and/or coordinate which user devices 102 are going to send a SL-PRS, receive a SL-PRS, and/or make SL-PRS measurements, such as for a positioning purpose.

In addition, in various embodiments, the out-of-coverage user device 102 (i.e., the user device 102 that broadcasts the positioning service request) may determine or acquire a SL-PRS configuration for sidelink communication. For at least some embodiments, the out-of-coverage user device 102 may determine or acquire the SL-PRS configuration by being pre-configured with the SL-PRS configuration. The SL-PRS configuration with which the out-of-coverage user device 102 is pre-configured may be considered a pre-defined SL-PRS. Also, in any of various embodiments, a SL-PRS configuration may include or be configured with at least one: a SL-PRS resource set and a corresponding SL-PRS resource set ID (for at least some embodiments a SL-PRS resource set may include one or more SL-PRS resources), a SL-PRS resource and a corresponding SL-PRS resource ID, a SL-PRS configuration set and a corresponding PRS configuration set ID (for at least some embodiments, a SL-PRS configuration set may include one or more SL-PRS resource sets).

Also, in various embodiments, out-of-coverage user devices 102 that belong to a same sidelink positioning session may compete and pick or select respective SL-PRS configurations with suitable time/frequency/spatial/code domain resources. For at least some of these embodiments, the out-of-coverage user devices 102 may select their respective SL-PRS configurations so as to avoid resource conflict. In addition or alternatively, the out-of-coverage user device 102 may select their respective SL-PRS configurations from according to their respective pre-configurations. In addition or alternatively, the out-of-coverage user devices 102 may select their respective SL-PRS configurations in a competing manner.

In addition, in some embodiments, out-of-coverage user devices 102 that belong to a same sidelink positioning session may each assume the roles of a target user device 102 or an anchor user device 102. After the sidelink positioning session is set up, the target user device 102 and anchor user device(s) 102 may each broadcast their respective chosen SL-PRS configurations (with each SL-PRS configuration including, for example, a PRS resource ID, a PRS resource set ID, and/or a PRS configuration set ID) associated with the user device identification (for example the UE ID, a source/destination user information of itself, or a source/destination layer-2 ID of itself), and/or a positioning session ID. The target and anchor user devices 102 may broadcast their respective SL-PRS configurations, user device identifications, and/or positioning session IDs in order to notify the other user devices 102 in the sidelink positioning session what kind of periodic SL-PRS they will each transmit at a later time.

Also, in any of various embodiments, a user device 102 may select only one SL-PRS configuration or a plurality of SL-PRS configurations. If only one SL-PRS configuration is chosen, the user device 102 may transmit a periodic SL-PRS according to the chosen SL-PRS configuration. If a plurality SL-PRS configurations are chosen, the user device 102 may select any one of the plurality of SL-PRS configurations, and transmit a periodic SL-PRS according to the selected one of the plurality of SL-PRS configurations.

Also, in at least some embodiments, before sending each instance of the periodic SL-PRS, the user device 102 may perform sensing to determine whether the configured time and frequency domain resources for the SL-PRS instance are unoccupied (or available, unused, or empty) or occupied (or unavailable or taken). If the time and frequency domain resources are unoccupied, the user device 102 may send the SL-PRS instance in those time and frequency domain resources. In addition, if the time and frequency domain resources are occupied, the user device 102 may skip this SL-PRS instance and monitor for a next SL-PRS instance. In addition, for at least some embodiments, the user device 102 may perform sensing to determine whether time and frequency domain resources are occupied for the SL-PRS instances without performing SCI sensing. Also, in various embodiments, the user device 102 may be configured or pre-configured with a sensing window and/or a selection window specific for SL-PRS. In any of various embodiments, the sensing window and/or the selection window for SL-PRS may or may not overlap with a SCI sensing configuration.

In addition, in order for a receiving user device 102 to monitor and/or receive a periodic SL-PRS from a transmitting user device 102, since the receiving user device 102 may have already received the broadcasted SL-PRS configuration according to which the periodic SL-PRS is transmitted, the receiving user device 102, may, correspondingly, already know the association between the SL-PRS configuration, the user device identification, and the positioning session. In event that only one SL-PRS configuration is associated with, and/or included in, a SL-PRS configuration broadcast, the receiving user device 102 may monitor the time and frequency domain resources according to the only one SL-PRS configuration in order to receive one or more instances of the periodic SL-PRS. In addition, if more than one SL-PRS configuration is associated with and/or included in the SL-PRS configuration broadcast, the receiving user device 102 may perform blind detection of each of the SL-PRS configurations included in the SL-PRS configuration broadcast.

In addition or alternatively, after the user devices 102 set up a sidelink positioning session, the user devices 102 may start to communicate (transmit and receive) a periodic SL-PRS. The user devices 102 may do so without using SCI communication and/or without triggering caused by communication of medium access control control elements (MAC-CE).

In addition or alternatively, after a transmitting user device 102 transmits multiple instances of a periodic SL-PRS, such as over multiple periods, a user device 102 in the SL positioning session (either the transmitting user device 102 or another user device 102 in the SL positioning session) may broadcast an association between at least one of the following: a user device identification (for example a UE ID, a source/destination user information of itself, or a source/destination layer-2 ID of itself), a SL positioning session ID, a SL-PRS time stamp it sent in a former time duration, the SL-PRS configuration (including, for example, a PRS resource ID, a PRS resource set ID, and/or a PRS configuration set ID) that the UE chooses in the former time duration. A SL-PRS timestamp may specify or indicate a precise, absolute, or particular time of one instance of a periodic SL-PRS. Accordingly, each SL-PRS instance may have or correspond to a respective SL-PRS timestamp. The user device 102 may record the SL-PRS timestamps for each or all of the SL-PRS instances it sends during the former time duration, where the former time duration is the time duration during which the transmitting user device 102 transmitted the multiple instances of the periodic SL-PRS prior to the broadcast of the association. Correspondingly, the other user devices 102 may monitor every configured time and frequency domain resources in order to receive SL-PRS instances of the periodic SL-PRS and measure time of arrival (TOA) and/or reference signal received power (RSRP) for each of the instances of the periodic SL-PRS. When other user devices 102 in the SL positioning session receive the association information in the later broadcast, the other user devices 102 may know which SL-PRS measurements belongs to which sending user device 102.

In addition or alternatively, after a sidelink positioning session is set up, and when the out-of-coverage user device 102 is to transmit a periodic SL-PRS, the user device 102 may transmit the periodic SL-PRS based on, or according to, a pre-defined or pre-configured SL-PRS configuration. The other user devices 102 in the SL positioning session may listen for the periodic SL-PRS by blindly detecting all time/frequency/spatial/code domain resources of, or indicated by, the pre-configured PRS configuration. In some embodiments, a user device identification may be embedded in a SL-PRS sequence ID. For at least some of these embodiments, the user device 102 may use all possible combinations of user device identifications in one sidelink positioning session and SL-PRS sequence IDs in a pre-configured PRS configuration in order to do perform the blind

In addition or alternatively, for some embodiments where a user device 102 is to transmit a periodic SL-PRS and the user device 102 chooses or selects a certain or particular SL-PRS configuration that indicates the certain time and frequency domain resources the periodic SL-PRS is to periodically occupy, the user device 102 may be configured with a timer that prevents the user device 102 from occupying these time and frequency domain resources indefinitely. For example, the timer may define or indicate a time duration (or a time length, a time window, or a time period). The timer may indicate that the user device 102 may transmit the periodic SL-PRS within the time duration indicated by the timer. In at least some embodiments, each SL-PRS configuration may be associated or configured with a timer.

Further, in various embodiments, the timer may start at a first time the user device 102 sends an instance of the periodic SL-PRS instance. When the timer ends, if user device 102 still needs to transmit one or more instances of the periodic SL-PRS, the user device 102 may change a SL-PRS configuration. In some embodiments, the same timer may be part of or available to all the pre-defined SL-PRS configurations.

In addition or alternatively, a SL-PRS configuration may also indicate a maximum number of instances of a periodic SL-PRS. Upon selection of a SL-PRS configuration, the user device 102 may transmit instances of a SL-PRS up to a number that does not exceed the maximum number indicated by the selected SL-PRS configuration. In various embodiments, the user device 102 may maintain a count, an increment the count each time the user device 102 transmits an instance of the periodic SL-PRS. If or when the count reaches the maximum number, the user device 102 may determine whether it wants to transmit more instances of the periodic SL-PRS. If it does, then the user device 102 may change the SL-PRS configuration. In various embodiments, each SL-PRS configuration may indicate a maximum number of SL-PRS instances, and/or a plurality of SL-PRS configurations may all have the same maximum number.

In addition, in some embodiments when a user device 102 changes a SL-PRS configuration because a timer expires, as part of, or in response to, changing the SL-PRS configuration, the user device 102 may broadcast a new association to neighbor user devices 102. The broadcast message indicating the new association may include the user device identification and/or the SL positioning session ID, as previously described.

In addition or alternatively, in some embodiments, when a user device 102 transmits periodic SL-PRS, the user device 102 may receive can receive signaling from the wireless access node 104 (e.g., the network) or from one or more other user devices 102 to stop transmitting the periodic SL-PRS. In addition or alternatively, when a user device 102 transmits a periodic SL-PRS, the user device 102 may receive signaling from the wireless access node 104 (e.g., the network) or from one or more other user devices 102 to change to another or different SL-PRS configuration for periodic SL-PRS transmitting. In response, the user device 102 may change to a different SL-PRS configuration, and transmit a new or second periodic SL-PRS according to the different SL-PRS.

In addition or alternatively, in some embodiments, a user device 102 that is transmitting or receiving a periodic SL-PRS may transmit or receive the periodic SL-PRS only in a configured time grid. This may have the desirable effect of restricting the number of instances of a periodic SL-PRS that is communicated. In some of these embodiments, the time grid is configured as a bitmap, where bits or bit values of the bitmap indicate available time units (e.g., available slots, available symbols, available subframes, or available frames) in which the periodic SL-PRS can be transmitted or received. Except for these indicated time units, the SL-PRS is not transmitted or received. In various embodiments, the time grid (e.g. bitmap) may be configured based on a pre-configured or a network-configured sidelink slots pattern.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:
A first aspect includes a method for wireless communication that includes: determining, with a user device, a sidelink positioning reference signal (SL-PRS) configuration; and transmitting, with the user device, a periodic SL-PRS according to the SL-PRS configuration.
A second aspect includes the first aspect, and further includes wherein the SL-PRS configuration comprises at least one of: a SL-PRS resource, a SL-PRS resource set, or a SL-PRS resource set list comprising a plurality of SL-PRS resource sets.
A third aspect includes any of the first or second aspects, and further includes broadcasting, with the user device, at least one of: a user device identification, a positioning session identification, or the SL-PRS configuration.
A fourth aspect includes the third aspect, and further includes wherein the user device broadcasts at least one of: the user device identification, the positioning identification, or the SL-PRS configuration before transmitting the periodic SL-PRS.
A fifth aspect includes the third aspect, and further includes wherein the user device broadcasts at least one of the user device identification, the positioning identification, the SL-PRS configuration, or a SL-PRS time stamp after transmitting the periodic SL-PRS.
A sixth aspect includes any of the first through fifth aspects, and further includes wherein the user device is configured with a time period, and wherein transmitting the periodic SL-PRS according to the SL-PRS configuration comprises transmitting the periodic SL-PRS within the time period.
A seventh aspect includes the sixth aspect, and further includes wherein the time period is configured per SL-PRS configuration.
An eighth aspect includes the sixth aspect, and further includes wherein the time period is configured among a plurality of SL-PRS configurations.
A ninth aspect includes any of the first through eighth aspects, and further includes wherein the user device is configured with a time bitmap, and wherein transmitting the periodic SL-PRS according to the SL-PRS configuration comprises transmitting the periodic SL-PRS according to an available time indicated by the time bitmap.
A tenth aspect includes any of the first through ninth aspects, and further includes wherein the user device is configured with a time bitmap, the method further comprising: receiving, with the user device, a SL-PRS within an available time indicated by the time bitmap.
An eleventh aspect includes any of the ninth or tenth aspects, and further includes wherein the time bitmap is configured based on a sidelink slot pattern.
A twelfth aspect includes a method for wireless communication, that includes: receiving, with a user device, a periodic sidelink positioning reference signal (SL-PRS); and performing, with the user device, at least one measurement based on the periodic SL-PRS.
A thirteenth aspect includes the twelfth aspect, and further includes wherein receiving the periodic SL-PRS comprises blindly detecting the periodic SL-PRS using at least one of: a user device identification or a PRS sequence identification.
A fourteenth aspect includes the twelfth aspect or the thirteenth aspect, in combination with any of the first through eleventh aspects.
A fifteenth aspect includes a wireless communications apparatus comprising a processor and a memory, wherein the processor is configured to read code from the memory to implement a method of any of the first through fourteenth aspects.
A sixteenth aspect includes a computer program product comprising a computer-readable program medium comprising code stored thereupon, the code, when executed by a processor, causing the processor to implement a method of any of the first through fourteenth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, with a user device, a sidelink positioning reference signal (SL-PRS) configuration; and
transmitting, with the user device, a periodic SL-PRS according to the SL-PRS configuration.

2. The method of claim 1, wherein the SL-PRS configuration comprises at least one of: a SL-PRS resource, a SL-PRS resource set, or a SL-PRS resource set list comprising a plurality of SL-PRS resource sets.

3. The method of claim 1, further comprising:
broadcasting, with the user device, at least one of: a user device identification, a positioning session identification, a specific service type identification, a sidelink positioning method, or the SL-PRS configuration.

4. The method of claim 3, wherein the user device broadcasts at least one of: the user device identification, the positioning session_identification, the specific service type identification, the sidelink positioning method, or the SL-PRS configuration before transmitting the periodic SL-PRS.

5. The method of claim 3, wherein the user device broadcasts at least one of the user device identification, the positioning session identification, the specific service type identification, the sidelink positioning method, the SL-PRS configuration, or a SL-PRS time stamp after transmitting the periodic SL-PRS.

6. The method of claim 1, wherein the user device is configured with a time period, and wherein transmitting the periodic SL-PRS according to the SL-PRS configuration comprises transmitting the periodic SL-PRS within the time period.

7. The method of claim 6, wherein the time period is configured per SL-PRS configuration.

8. The method of claim 6, wherein the time period is configured among a plurality of SL-PRS configurations.

9. The method of claim 1, wherein the user device is configured with a time bitmap, and wherein transmitting the periodic SL-PRS according to the SL-PRS configuration comprises transmitting the periodic SL-PRS according to an available time indicated by the time bitmap.

10. The method of claim 1, wherein the user device is configured with a time bitmap, the method further comprising:
receiving, with the user device, a SL-PRS within an available time indicated by the time bitmap.

11. The method of claim 9, wherein the time bitmap is configured based on a sidelink slot pattern.

12. A method for wireless communication, the method comprising:
receiving, with a user device, a periodic sidelink positioning reference signal (SL-PRS); and
performing, with the user device, at least one measurement based on the periodic SL-PRS.

13. The method of claim 12, wherein receiving the periodic SL-PRS comprises blindly detecting the periodic SL-PRS using at least one of: a user device identification or a PRS sequence identification.

14. A wireless communications apparatus comprising a processor and a memory, wherein the processor is configured to read code from the memory to implement a method of claim 1.

15. A non-transitory computer program product comprising a computer-readable program medium comprising code stored thereupon, the code, when executed by a processor, causes the processor to execute the following operations:
determining, with a user device, a sidelink positioning reference signal (SL-PRS) configuration; and
transmitting, with the user device, a periodic SL-PRS according to the SL-PRS configuration.

16. The non-transitory computer program product according to claim 15, wherein the SL-PRS configuration comprises at least one of: a SL-PRS resource, a SL-PRS resource set, or a SL-PRS resource set list comprising a plurality of SL-PRS resource sets.

17. The method according to claim 1, wherein the SL-PRS configuration comprises at least one of: a SL-PRS resource set and a corresponding SL-PRS resource set ID, a SL-PRS resource and a corresponding SL-PRS resource ID, a SL-PRS configuration set and a corresponding PRS configuration set ID.

18. The method according to claim 1, further comprising: when the user device transmits periodic SL-PRS, receiving, with the user device, a signaling from a wireless access node or from one or more other user devices to stop transmitting the periodic SL-PRS.

19. The method according to claim 12, wherein the at least one measurement comprises at least one of: reference signal time difference (RSTD), time of arrival (TOA), a Rx-Tx time difference measurement, SL-PRS reference signal received power (SL-PRS-RSRP), SL-PRS reference signal received power per path (SL-PRS-RSRPP), or the receiving angle of the periodic SL-PRS.

20. The method according to claim 12, further comprising: sending, with the user device, a confirm message to a second user device, wherein the confirm message comprises at least one of: a user device identification of the user device, a user device identification of the second user device, a positioning service type identification, a positioning session identification.
